(19) United States
(12) Patent Application Publication
(10) Pub. No.: US 2021/0071531 A1
(43) Pub. Date: Mar. 11, 2021

(54) FULLY SCALABLE CONTROLLED-FRACTURE MACHINED TURBOMACHINE APPARATUS

(71) Applicant: Tennine Corp., Grand Rapids, MI (US)

(72) Inventors: William Q. Tingley, Grand Rapids, MI (US); William Q. Tingley, III, Grand Rapids, MI (US); Daniel R. Bradley, Grand Rapids, MI (US)

(21) Appl. No.: 16/667,325

(22) Filed: Oct. 29, 2019

Related U.S. Application Data
(60) Provisional application No. 62/754,741, filed on Nov. 2, 2018.

(51) Int. Cl. F01D 5/02; B23C 3/00

(52) U.S. Cl. CPC F01D 5/02; B23C 3/00; F05D 2240/24; F05D 2230/10; F05D 2220/32

(57) ABSTRACT

A fully scalable turbomachine in which one or more of its components, in particular its bladed components, such as a blisk, is manufactured by controlled-fracture machining. The practical effects of the invention are (1) to improve the quality of current turbomachine components at greater rates of production and lower costs, (2) to increase the performance and the range of uses of current turbomachine functions, and (3) to enable new uses of turbomachines that are currently restricted by the lack of scalability and practicality in manufacturing. The most preferred embodiment of the invention is the gas turbine functioning as a jet engine or a turboshaft engine either for propulsion or for power generation.

### FIELD OF THE INVENTION

The invention pertains to the field of power generation. Specifically, it is a turbomachine. It is capable of performing any function that all other turbomachines of prior art currently do. The invention is distinguished from prior art by the manufacture of one or more of its components by controlled-fracture machining. This enables the creation of turbomachines at scales, complexity in geometry, reduced mass, and ease of production currently not possible with conventional methods of manufacture. Thus, the invention creates applications of turbomachines for purposes that are currently impossible or impractical. This is especially true for turbomachines known as gas turbines for propulsion and power generation.

### BACKGROUND OF THE INVENTION

### Turbomachines

A turbomachine converts energy from a flow of fluid into useful work. There are two basic types of turbomachines: The impulse turbine and the reactionary turbine. The impulse turbine can be as simple as a shaft with attached blades exposed to a fluid flow. The flow spins this turbine axially to produce torque. The waterwheel is an example. Specifically, the impulse turbine produces torque by changing the direction of a fluid flow by its impact against the turbine's blades under the principle of Newton's Second Law. Fundamentally an impulse turbine's torque is developed from the reduction of the fluid flow's kinetic energy. The flow's pressure does not change.

The reactionary turbine is more common today. Unlike the impulse turbine, the reactionary turbine produces torque from a pressure change in the fluid flow which then drives the turbine's blades under the principle of Newton's Third Law. A reactionary turbine is typically a gas turbine, also known as a “turbine engine”. A gas turbine increases the energy available to produce torque by compressing the flow and then combusting a fuel to add heat to the fluid flowing to the turbine.

### Machining Processes

The components of a gas turbine are typically metal, usually steel which is often a heat-resistant alloy with a high nickel content. They are manufactured by various methods including casting, forming, and machining. The compressor and turbine components are the most difficult to manufacture because compound curves define the geometry of their blades. Ideally these components are in the form of a precision-machined blisk, in which the blades and their base constitute a single unit. As used herein, the term “blisk” means a turbomachine component comprising both rotor disk and a plurality of curved blades projecting orthogonally from the surface of the disk. Together the blisk blades and the base form a geometrically complex surface that cannot be precisely machined to net shape by conventional machining methods that are currently in use, such as milling. Presently, this results in compromises between the ideal design and producibility.

Computer numerical-controlled milling of a blisk is the current state of the art for a high-performance gas turbine. The method of milling most often used is cutting with a ball-nose end mill. An end mill must spin on its axis to produce sufficient torque to cut the workpiece to the desired shape. By its nature this imposes axial symmetry upon the end mill as a cutting tool. This significantly restricts the shapes that an end mill can cut into a workpiece to manufacture a blisk, especially its blades. The end mill's axial symmetry also frequently creates interference problems with the compound curves of the blades, which results in the end mill cutting away previously machined portions of the blades to reach deeper surfaces to subsequently machine.

Furthermore, milling by rotating a cutting tool requires fluting the end mill with a plurality of cutting edges. When the end mill is spun to produce torque, these flutes rotate in and out of the workpiece. Thus, the cut is not continuous but interrupted. This significantly restricts the performance of the end mill, especially in terms of the rate of volumetric removal of material from the workpiece to manufacture a blisk. Moreover, this discontinuous plastic deformation of the workpiece imparts heat to it which makes the milling of thin cross-sections imprecise, impossible, or prone to fracture from embrittlement.

Overcoming these limitations in scalability, geometric complexity, reduced mass, and ease of production with updated methods of machining bladed turbomachine components creates the need for the invention. It makes possible the manufacture of turbomachines, in particular gas turbines, of all sizes with enhanced performance at lower costs and faster rates of production.

### SUMMARY OF THE INVENTION

Various embodiments of the present invention are directed to a turbomachine in which one of more of its components, typically the bladed components, are produced by controlled-fracture machining to make possible the manufacture of high-performance turbomachines, gas turbines in particular, for applications that are outside the range of current turbomachines. The most useful applications made possible by the invention are small-scale gas turbines for propulsion of vehicles currently powered by reciprocating engines and electric batteries and for off-grid power generation for residential, commercial, and industrial buildings.

### BRIEF DESCRIPTION OF THE DRAWINGS

The accompanying figures, where like reference numerals refer to identical or functionally similar elements throughout the separate views and which together with the detailed descriptions below are incorporated in and form part of the specification, serve to further illustrate various embodiments and to explain various principles and advantages all in accordance with the present invention.

FIG. 1 is a diagram of the basic components and their arrangement for a gas turbine engine.

FIG. 2 is a diagram of the basic components and their arrangement for a gas turbine engine configured as a jet engine.

FIG. 3 is a diagram of the basic components and their arrangement for a gas turbine engine configured as a turboshaft engine driving a device for either power generation or transmission for propulsion.

FIG. 4A, FIG. 4B and FIG. 4C are examples of a small, complex blisk employed as a high-efficiency compressor or turbine, the geometry of which permits only the use of controlled-fracture machining for rapid, precise, and net shape production of it. Illustrated are a plan view in FIG. 4A, an elevation view in FIG. 4B, and an isometric view in FIG. 4C.

FIG. 5A, FIG. 5B, FIG. 5C, FIG. 5D, FIG. 5E, and FIG. 5F illustrate the in-process controlled-fracture machining of a blisk fixtured on a 5-axis machine tool.

Skilled artisans will recognize that the figures illustrate the invention's elements, including its principles, elements, embodiments, and advantages, for simplicity and clarity. Therefore skilled artisan will also recognize that these elements are not necessarily to scale, may be exaggerated, and are not intended as mechanical drawings or other such production documents.

### DETAILED DESCRIPTION

Before describing in detail embodiments that are in accordance with the present invention, it should be observed that the embodiments reside primarily in combinations of method steps and apparatus components related to a fully scalable controlled-fracture machined turbomachine apparatus. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The processes for removing workpiece material is called “controlled fracturing” which occurs by applying an impact force that simultaneously exceeds the yield strength and the breaking strength of the workpiece material so to prevent plastic deformation. A controlled fracture is produced by an impact which causes an axial projection of banding along the perimeter of the tool to produce a repeatable, precise removal of workpiece material. As will be described herein, the controlled-fracture machining feature of the invention provides four key advantages over existing turbomachines: (1) Full scalability in size increasing the range of applications, (2) greater geometric complexity of the bladed components for improved performance, (3) greater precision and less distortion in machining thin cross-sections making possible greater reduction in the blisk's mass, thus lowering the pressure needed to rotate the blisk, and (4) ease of production reducing cost and time of manufacture while improving precision and dimensional accuracy.

Controlled-fracture machining overcomes these inherent limitations in the current use of computer numerical-controlled milling of the compressor 101, 202, 301 and turbine 103, 204, 303, 305 components of a gas turbine 100, 200, 300, especially when those components are in the favored form of a blisk 400. Controlled-fracture machining does not rely upon torque as a cutting force. The cutting tool 504 is driven strictly by linear forces through the blisk workpiece 500, 501, 502, 503 to machine to net shape its geometrically complex surface 402 of blades 401 integrated with the blisk's base 403.

Thus, controlled-fracturing to produce the desired net shape is induced in the workpiece using steps of applying an abrupt, localized, and substantially extreme force of a cutting tool 504 against the workpiece 500, 501, 502, 503. This force must be sufficient to exceed the ultimate shear strength of the material of the workpiece. When the force is applied, shear bands form in the workpiece as a microstructure of cracks emanating in the direction of the cutting tool 504 within the outside contour 505 of the cutting tool as projected into the workpiece 500, 501, 502, 503. Under the continued force of the cutting tool moving through the workpiece, this microstructure softens relative to the uncut material surrounding it, because the cracked material becomes highly fractured, even to the point of recrystallizing. Once softened the cutting tool shears this material from the workpiece as waste retaining almost all of the heat generated by the process, because its microstructure of cracks retards the transfer of heat to material outside of the microstructure. The end result of this controlled-fracturing process is a shape 402 cut into the workpiece 500, 501, 502, 503 with the same contour 505 as the cutting tool 504.

The forces sufficient to propagate the shear bands for controlled-fracture varies with the material of the workpiece. The cutting tool must apply at least 60,000 pounds of force per square inch (lbs/sq-in) of areal contact with the workpiece if it is cold-rolled mild steel, 80,000 pounds for alloy steel, 150,000 pounds for stainless steel, 50,000 pounds for titanium, and 20,000 pounds for aluminum. These forces can be applied as required to achieve the necessary surface footage for achieving controlled fracturing. More information regarding controlled-fracture machining is fully described in Applicant's U.S. Patent Publication No. 2005/0174784 entitled METHOD AN APPARATUS FOR NON-ROTARY HOLEMAKING BY MEANS OF CONTROLLED FRACTURING assigned to Tennine, Inc. and incorporated by reference herein in its entirety.

Employing linear force by means of controlled-fracture machining eliminates restrictions on the shape and size of the cutting tool 504 so that its cutting edge 505 can more closely conform to the ideal design 402. This also keeps the cutting tool continuously in cut as it is driven through the blisk workpiece 500 501 502 503 and increases the rate of volumetric material removal by orders of magnitude over current methods of machining. For example, the blisk 400 may use a 6-inch diameter base 403 with compound-curved blades 401 that are 0.030-inch thick and separated by a 0.100- to 0.141-inch tapered gap 402. (The dimensions of this example do not indicate any restrictions in the size and complexity of the blisks that can be machined by controlled-fracturing. Blisks configured one-tenth to ten times (10x) the size of the example, and beyond, can be machined under the same principles, because this method of production is fully scalable.) With the blisk fixtured 507 on a five-axis controlled-fracture machining center 506, for example, the blisk workpiece 400 can be presented at any angle and orientation that maximizes the performance of the cutting tool 504. Typical of this performance on a blisk is moving a 0.100-inch wide cutting tool through the blisk workpiece 500 501 502 503 at a feed rate of 1,200 inches a minute, thus completing the blisk 400 to a precision, finely finished, net shape surface 402 in about 10 minutes time.

The various embodiments of the invention are fully scalable in size because controlled-fracture machining can produce the bladed components 400 of a turbomachine to a precise net shape 402 of the ideal design. This is because controlled-fracture machining drives the cutting tool 504 with linear force 500, 501, 502, 503 instead of torque and so the cutting tool does not have axial symmetry imposed upon it. It can be any shape the geometry of the component's surface 402 requires. Current methods of milling use rotating axially symmetric cutting tools that can only approximate the ideal design. As a consequence, the turbomachine must be large enough so that this discrepancy in approximation is not so great as to significantly compromise the turbomachine's performance. The controlled-fracture machining feature of the invention, by means of asymmetrical cutting tool 504 driven by linear force 500, 501, 502, 503, overcomes this discrepancy so that smaller turbomachines, especially gas turbines 100, 200, 300, can be manufactured without compromising the integrity of their design and so their performance.

Those skilled in the art will recognize that the invention has the advantage of greater geometric complexity in the design of a bladed component's 400 surface 402 to improve the performance of a turbomachine, especially the gas turbine 100, 200, 300. The complexity is one of compound curves, often curve on curve on curve, in which the blades 401 of an intake 201, a compressor 101, 202, 301, or a turbine 103, 204, 303, 305 are folded over themselves or even over the neighboring blade. This complexity provides a greater surface area over a volume of fluid flow so that a flow pressure, lower than that needed to turn the bladed components of existing turbomachines, is sufficient for operation of the invention. Like scalability, this greater geometric complexity is possible because of the controlled-fracture machining feature of the invention and its employment of linear-force driven 500, 501, 502, 503 asymmetrical cutting tools 504 that can be shaped with the cutting edges 505 and clearances needed to precisely machine, without clearance problems or interference with previously machined surfaces, to net shape 402 curve on curve on curve folded blades 401 of an intake 201, a compressor 101, 202, 301, a turbine 103, 204, 303, 305 or other bladed component of a turbomachine.

Those skilled in the art will also recognize that controlled-fracture machining's use of linear force, as opposed to conventional milling's use of torque, to provide sufficient force to remove material from the workpiece 500, 501, 502, 503 enables the machining of very thin cross-sections 402 with precision and no distortion or embrittlement from heat caused by the plastic deformation of milling. This permits the production of blisks with less mass, which in turn require less pressure from fluid flows to rotate the blisk. Thus, the performance of blisks with thin cross-sections is enhanced, especially in small gas turbines that are currently impractical or impossible to produce because of the minimum pressures required to initiate the rotation of bladed components.

As seen in the accompanying figures, the invention has the advantage of ease of production over existing turbomachines. Like the other key advantages, this is because of the controlled-fracture machining feature of the invention. Controlled-fracture machining employs linear force rather than torque, which milling by rotation of the cutting tool requires, to drive an asymmetric cutting tool 504 through the workpiece 500, 501, 502, 503 to remove material. As a consequence, the volumetric rate of material removal by controlled-fracture machining is greater than milling by an order of one to two magnitudes. Furthermore, the material removal results in the ideal design net shape 402 that requires no further processing rather than approximation of it through milling which may require further machining or handwork to produce an acceptable component. Additionally, this faster and simplified machining process makes possible cost-effective shorter runs of components. Overall, the invention's ease of production simplifies the manufacture, reduces the cost, shortens the production time, improves the precision and dimensional accuracy, and increases the flexibility of producing turbomachine components, especially the bladed components 400 of the gas turbine 100, 200, 300. In addition to making possible the manufacture of turbomachines, especially gas turbines, for new applications, these same advantages also make the invention useful for existing applications through improved performance, lower costs, faster production, and greater precision in manufacture.

FIG. 1 is a diagram of the basic components and their arrangement for a gas turbine engine. All gas turbines 100 have at least four components: (1) An upstream compressor 101, (2) a downstream turbine 103 (in the industry “turbine” is a term of art for both entire gas turbine assembly 100 and this torque-producing component 103), (3) a shaft 104 which attaches the turbine to the compressor so that the rotation of the turbine drives the compressor, and (4) a combustor 102 between the compressor and the turbine.

A gas turbine 100 operates as follows: (1) The fluid flows into the compressor 101, (2) the compressor compresses the flow, which increases its velocity, (3) the compressed flow enters the combustor 102 which heats and adds energy to the flow, (4) the flow exits the combustor to turn the turbine 103, (5) the turbine turns to drive the compressor by means of the shaft 104 connecting them, and (6) the flow exits the turbine through a nozzle 206, in the simplest form of a gas turbine, as a jet to provide propulsion, or to drive a device 307 either for power generation or for transmission for propulsion.

Hence, the invention embodied as a gas turbine best exploits the key advantages of scalability, greater geometric complexity, reduced mass, and ease of production. Furthermore, the invention's embodiment as a gas turbine makes possible new applications for the gas turbine that are in demand but current gas turbines are not suited for because of high cost, difficulty of manufacture, size, weight, or other economic or physical limitations.

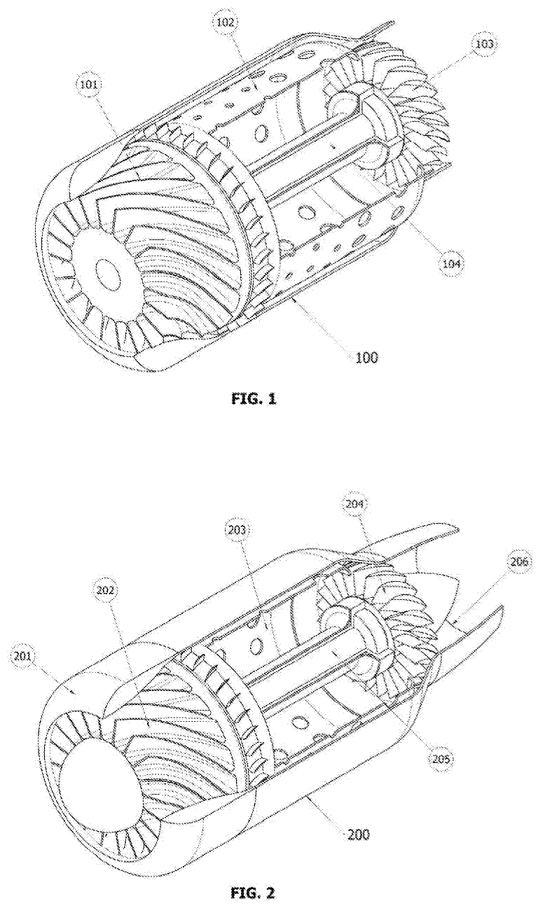

FIG. 2 is a diagram of the basic components and their arrangement for a gas turbine configured as a jet engine. As seen in FIG. 2, a functioning basic jet engine 200 consists of an intake 201, a compressor 202, a combustor 203, a turbine 204, a shaft 205 connecting the compressor to the turbine, and a nozzle 206. One or more of the bladed components, the intake, the compressor, or the turbine, is manufactured by controlled-fracture machining in the form of a bladed ring for the intake and a blisk for the compressor and the turbine. The controlled-fracture machining feature of the invention enables it to be embodied as a small-scale jet engine to propel marine vessels and aircraft that are too small for the weight and size of current jet engines. This includes surface and subsurface waterjet vessels, small aircraft, vertical take-off and landing aircraft, helicopters, and drones. Controlled-fracture machining also enables the production of bladed components with sufficient geometric complexity and reduced mass to exploit lower pressure flows of fluid for the small-scale applications of the invention as a jet engine.

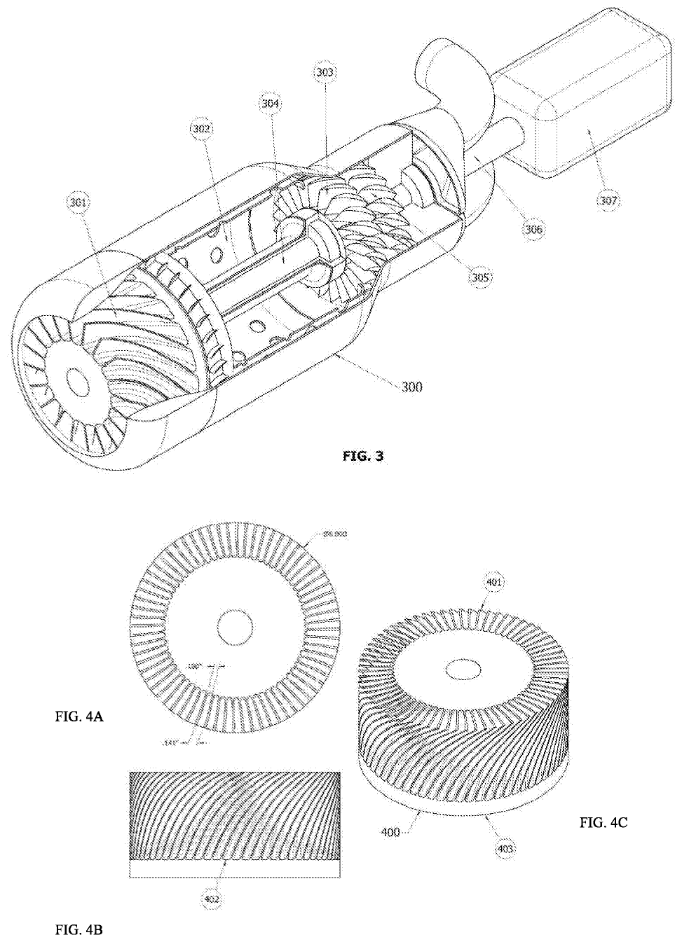

FIG. 3 is a diagram of the basic components and their arrangement for a gas turbine engine configured as a turboshaft engine driving a device for either power generation or transmission for propulsion. In this embodiment, the invention functions as a basic turboshaft engine 300 that consists of a compressor 301, a combustor 302, a primary turbine 303, a shaft 304 connecting the compressor to the primary turbine, a secondary turbine 305, and a secondary shaft 306 connecting the secondary turbine to a device 307 for power generation or transmission for propulsion. To improve the performance of the compressor, the invention as a turboshaft engine can be coupled with a turbocharger, a turbopump, or a fan, all of which can be produced by controlled-fracture machining. Like the jet engine embodiment 200, the controlled-fracture machining feature of the invention enables the turboshaft engine 300 to be manufactured for small-scale applications for power generation and propulsion that are not possible or practical for current turboshaft engine designs.

For power generation, the secondary turbine 305 of the turboshaft engine 300 embodiment of the invention drives a power generation device 307. This device is typically an electric generator that is powered by the turboshaft engine's conversion of a wind, water, air, or geothermal flow. Coupled with a turbocharger, turbopump, or fan the performance of the compressor 301 is increased under low pressure flows of these fluids. Because of controlled-fracture machining, small scales, geometric complexity of the bladed components, and reduced mass of those components enable the manufacture of small off-grid turboshaft engine embodiments of the invention to generate electricity for automobiles, aircraft, marine vessels, buildings, small property developments, among other things. In particular, this electric generator embodiment of the invention obsoletes battery electric vehicles, because it eliminates the need for a large pre-charged battery to power the vehicle. Thus, FIG. 3 illustrates variations where the turboshaft engine 300 has an additional secondary turbine 305 that rotates a co-axial shaft 306 that is independent of the main shaft 304. This secondary shaft can extend rearward to drive a device 307 either for power generation or for transmission for propulsion. Those skilled in the art will also recognize that the secondary shaft can also extend forward working to drive a propeller or a turbocharger, turbopump or turbofan for propulsion.

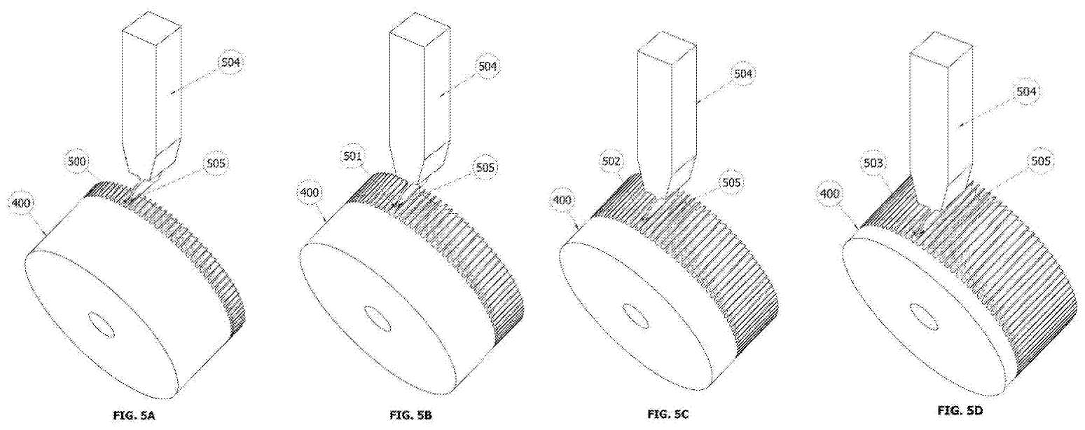

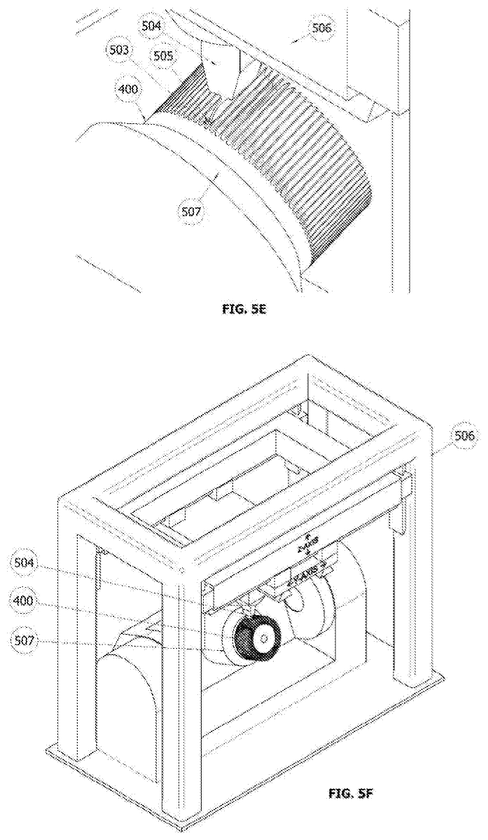

FIG. 4A, FIG. 4B and FIG. 4C are an example of a small, complex blisk 400 employed as a high-efficiency compressor or turbine, the geometry of which permits only the use of controlled-fracture machining 500, 501, 502, 503 for the rapid, precise production of its net shape 402. Illustrated are a plan view in 4A, an elevation view 4B and an isometric view in 4C. In addition to new applications for jet and turboshaft engines, the invention's embodiments of these types of gas turbines for current applications makes these engines less expensive, quicker to manufacture, more flexible in materials used, reduced in mass, higher in performance, and more precise in shape and dimension because of the controlled-fracture feature of the invention. In comparison, conventional machining (that is, by plastic deformation) of the blisk workpiece with a ball-nose end mill (ignoring the fact of the impracticality if not impossibility of a such a tool being capable of machining the entire surface of the blisk without cutting into the compound-curved blades) would be limited to a feed rate as little as one-thousandth of controlled-fracture machining and take 160 hours or more to complete to a rough, approximated net shape surface in contrast to the 10 minutes to complete by controlled-fracture machining.

FIG. 5A through FIG. 5D illustrate Z-level machining in which the finished surface to be produced is oriented perpendicularly to the cutting edge of the asymmetrical control-fracture cutting tool at various Z-levels. FIG. E and FIG. F illustrate the blisk and the cutting tool fixtured on a 5-axis bridge-type machining center to machine the finished surface at the Z-level illustrated in FIG. 5D. The steps used in the manufacturing process of the blisk 400 for use as a component of a gas turbine 100, 200, 300 include but are not limited to fixturing 507 a metallic, carbon-fiber, or plastic workpiece 400 to a table of the multi-axis machine tool 506 and then adjusting either the asymmetrical cutting tool 504 or workpiece 400 so that the cutting face 505 of the tool is typically perpendicular to the desired finished surface 402, and so an optimal cutting force 500 501 502 503 can be achieved. The surface of the workpiece is approached with the cutting tool to a level sufficient to clear obstructions and to allow acceleration of the cutting tool to the speed required for controlled fracturing. Thereafter, the cutting tool 504 driven without rotation about its axis into the workpiece 500, 501, 502, 503 using a force of at least 20,000 lbs/sq-in through the use of controlled fracturing by simultaneously exceeding the yield strength and the breaking strength of the workpiece material by an impact to cause the axial projection of banding along the perimeter of the tool 505. A desired amount of workpiece material is removed to form at least one blade 401 that conforms to the perimeter of the cutting face 505 of the cutting tool 504. The cutting tool is then withdrawn from the workpiece to a predetermined level and reset using the drive mechanism in a computer-numerical controlled machine tool 506. These steps are repeated until the desired amount of work piece material is removed to form the blisk 500, 501 502, 503. Finally, the cutting tool is retracted from a work envelope when a desired disk shape 402 has been achieved.

Thus, embodiments of the present invention are directed to the production of a blisk, a bladed ring, and other similar bladed turbomachine components using the process of controlled fracture. By removing material from the workpiece through the use of controlled fracture, as opposed to plastic deformation of conventional milling, heat from the machining process is retained in the waste and not imparted to the workpiece. Therefore, thin and geometrically complex cross-sections can be machined without compromising the physical, structural, and dimensional integrity of the workpiece.

Controlled-fracture machining significantly increases the ease of production and the geometric complexity of the bladed components of turbomachines while manufacturing them more closely to their ideal design. Controlled-fracture machining also makes possible the manufacture of turbomachines, especially gas turbines, across the full scale of practical sizes. This is true in particular for smaller scale turbomachines, because current methods are relatively crude and cannot reproduce the ideal design of the geometric complexity of bladed components such as an intake, compressor and turbine. Therefore, to approximate the ideal design, only larger scale turbomachines are practical or even possible to manufacture.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A blisk for use with a turbomachine prepared by a process comprising the steps of:
providing a metallic, carbon-fiber, or plastic workpiece;
driving a cutting tool into the workpiece using at least 20,000 lbs/sq-in of an impact induced force to produce controlled fracturing which exceeds both the yield strength and the breaking strength of the workpiece material by an impact force which causes the axial projection of adiabatic shear banding of the workpiece material along a perimeter of the cutting tool; and
removing desired amounts of material from the workpiece at precise locations to create both a disk and a plurality of blades without causing its plastic deformation.

2. A blisk for use with a turbomachine as in claim 1, wherein the blisk is substantially cylindrical in shape.

3. A blisk for use with a turbomachine as in claim 1, wherein the shape of the plurality of blades around the disk are identical.

4. A blisk for use with a turbomachine as in claim 1, wherein the blisk forms a complex surface that cannot be produced using milling processes.

5. A blisk for use with a gas turbine engine manufactured by a process comprising the steps of:
fixturing a workpiece to a table;
positioning a face of a cutting tool substantially perpendicular to a surface of the workpiece;
approaching the surface of the workpiece with the cutting tool to a predetermined clearance level;
driving the cutting tool into the workpiece through the use of controlled fracturing by simultaneously exceeding the yield strength and the breaking strength of the workpiece material so to prevent plastic deformation by an impact which causes the axial projection of banding along the circumference of the tool to remove desired amounts of workpiece material without plastic deformation;
withdrawing the cutting tool from the workpiece to a predetermined level;
resetting the cutting tool using a drive mechanism;
repeating the step of driving an asymmetrical cutting tool through the workpiece to form both a disk and plurality of blades; and
retracting the cutting tool from a work envelope upon completion of the blisk manufacturing process.

6. A blisk for use with a gas turbine engine manufactured by a process as in claim 5, further comprising the step of:
providing a force of at least 20,000 lbs/sq-in to remove predetermined amounts of workpiece material having a desired size and shape to form the blisk.

7. A blisk for use with a gas turbine engine manufactured by a process as in claim 5, further comprising the step of:
creating shear bands in the workpiece that emanate from the face of the cutting tool using the forces provided by the cutting tool to form the disk and plurality of blades in the blisk.

8. A blisk for use with a gas turbine engine prepared by a process comprising the steps of:
fixturing a metallic, carbon-fiber, or plastic workpiece to a table of the multi-axis machine tool;
adjusting the cutting face of a machine tool by rotating the cutting tool or workpiece so that an optimal cutting force can be achieved;
approaching the surface of the workpiece with the cutting tool to a level sufficient to clear obstructions and to allow acceleration of the cutting tool to the speed required for controlled fracturing;
driving the cutting tool without rotation about its axis into the workpiece using a force of at least 20,000 lbs/sq-in through the use of controlled fracturing by simultaneously exceeding the yield strength and the breaking strength of the workpiece material by an impact to cause the axial projection of banding along the perimeter of the tool;
removing desired workpiece material to form at least one blade that conforms to the perimeter of the cutting face of the cutting tool;
withdrawing the cutting tool from the workpiece to a predetermined level;
resetting cutting tool using the drive mechanism;
repeating the step of removing desired work piece material; and
retracting the cutting tool from a work envelope when a desired disk shape has been achieved.

9. A blisk for use with a gas turbine engine as in claim 8, further comprising the steps of:
removing material to form the blisk without a counterstrike, die, or other counter-tool used on the opposite side of the workpiece.
